(19) United States
(12) Patent Application Publication
(10) Pub. No.: US 2008/0135051 A1
(43) Pub. Date: Jun. 12, 2008

(54) Air Line Adapter Structure Of Suction Apparatus

(76) Inventor: George Lee, Taipei (TW)

Correspondence Address: HDSL, 4331 STEVENS BATTLE LANE, FAIRFAX, VA, 22033, US

(21) Appl. No.: 11/567,854

(22) Filed: Dec. 7, 2006

(51) Int. Cl. A62B 9/04

(52) U.S. Cl. 128/207.14

(57) ABSTRACT

An air line adapter structure includes a connecting tube body and an air adapter. The connecting tube body includes an air tube connector, a breathing connector interconnected with the air tube connector and a suction connector interconnected with the air tube connector and the breathing connector. The air adapter includes a sheathing bushing and a connecting tube extended outward from a sheathed bushing, and the interior of the sheathing bushing is interconnected with the interior of the connecting tube and sheathed onto the breathing connector of the connecting tube body. The external circumference of the connecting tube is smaller than the external circumference of the sheathing bushing, such that the connecting tube can be connected directly to an oxygen tube for timely supplying oxygen to patients and greatly broadening the scope of application of the suction apparatus.

### BACKGROUND OF THE INVENTION

1. Field of the Invention

The present invention relates to a suction apparatus, and more particular to a suction apparatus with an air line adapter structure.

2. Description of Prior Art

In general, doctors usually use a suction apparatus having both suction and oxygen supply functions for a tracheotomy patient who needs a breathing apparatus for the treatment, and manufacturers spare no effort to conduct research and development to develop various suction apparatuses including different components and various connections, and thus the application of suction apparatuses become broader and more popular.

A conventional air line structure of a suction apparatus as disclosed in R.O.C. Pat. No. M243213 includes a connecting tube body and a breathing tube sleeve. The connecting tube body includes an air tube connector, a breathing connector and a suction connector, wherein the air tube connector is connected to an air tube, and the breathing connector is connected to a serpentine tube of a breathing apparatus, and the breathing apparatus is comprised of a cylindrical tube and a ring, and the exterior of the cylindrical tube has a flange for inserting an end of the cylindrical tube into the breathing connector, and the front end of the flange presses precisely on a distal surface of the breathing connector, and an internal periphery of the ring has a concave line for receiving another end of the cylindrical tube and latching the bottom of the flange, so as to define an air line structure of a suction apparatus.

However, the air line structure of a conventional suction apparatus still has the following issues. Since a general ward usually does not have a serpentine tube for the breathing apparatus, therefore the suction apparatus cannot be connected to an oxygen delivery device, and the conventional structure greatly limits the location and place of using such suction apparatus. Further, a breathing tube sleeve has a cylindrical tube, and thus a leak of gas occurs easily at a position that connects the breathing tube sleeve and the cylindrical tube, or the breathing tube sleeve and the cylindrical tube may be detached from each other, when the breathing tube sleeve is connected to the serpentine tube. If the breathing tube sleeve is not in use, it is necessary to cover the cylindrical tube with a cap, but the cap and the cylindrical tube are installed separately, and users sometimes cannot find the cap when needed. Therefore, the conventional suction apparatus requires further improvements.

### SUMMARY OF THE INVENTION

In view of the foregoing shortcomings of the prior art, the inventor of the present invention based on years of experience in the related industry to conduct experiments and modifications, and finally invented an air line adapter structure of a suction apparatus.

Therefore, the present invention is to provide an air line adapter structure of a suction apparatus connected to a connecting tube body by an air adapter, and the connecting tube is connected directly to a general oxygen tube for timely supplying oxygen gas to a patient and greatly broaden the scope of application of the suction apparatus.

To achieve the objective, the present invention provides an air line adapter structure of a suction apparatus comprising a connecting tube body and an air adapter, wherein the connecting tube body comprises an air tube connector, a breathing connector interconnected with the air tube connector, and a suction connector interconnected to the air tube connector and the breathing connector; and the air adapter comprises a sheathing bushing and a connecting tube extended from an end of the sheathed bushing, and the interior of the sheathing bushing is interconnected with the interior of the connecting tube, and the sheathing bushing is sheathed onto the breathing connector of the connecting tube body, and the external circumference of the connecting tube is smaller than the external circumference of the sheathing bushing.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is an exploded view of the present invention;

FIG. 2 is a perspective view of the present invention;

FIG. 3 is a perspective view of an air line adapter connected to an oxygen tube and a suction tube in accordance with the present invention;

FIG. 4 is a perspective view of an adapter of another preferred embodiment of the present invention.

### DETAILED DESCRIPTION OF THE INVENTION

The technical characteristics, features and advantages of the present invention will become apparent in the following detailed description of the preferred embodiments with reference to the accompanying drawings. The drawings are provided for reference and illustration only, but not intended for limiting the present invention.

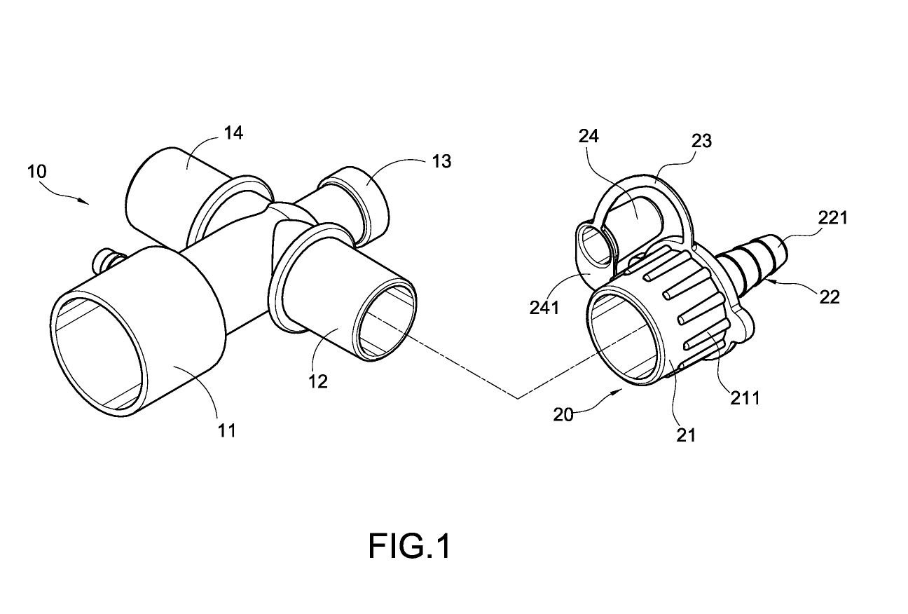

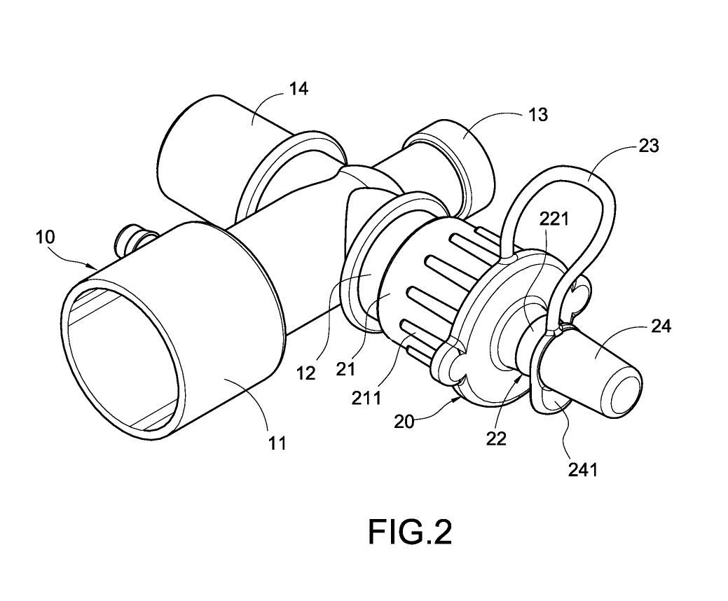

Referring to FIGS. 1 and 2 for an exploded view and a perspective view of the present invention respectively, the invention provides an air line adapter structure of a suction apparatus, comprising a connecting tube body 10 and an air adapter 20 as described below.

The connecting tube body 10 can be in a cross-shape (adopted in this embodiment) or any other shape, and the connecting tube body 10 includes an air tube connector 11, a breathing connector 12, a suction connector 13 and a standby connector 14, and the air tube connector 11 is substantially a cylindrical body disposed at the top of the connecting tube body 10; both breathing connector 12 and standby connector 14 are cylindrical bodies disposed vertically on both left and right sides of the air tube connector 11; and the suction connector 13 is disposed precisely under the air tube connector 11, and the suction connector 13, the air tube connector 11, the breathing connector 12 and the standby connector 14 are interconnected.

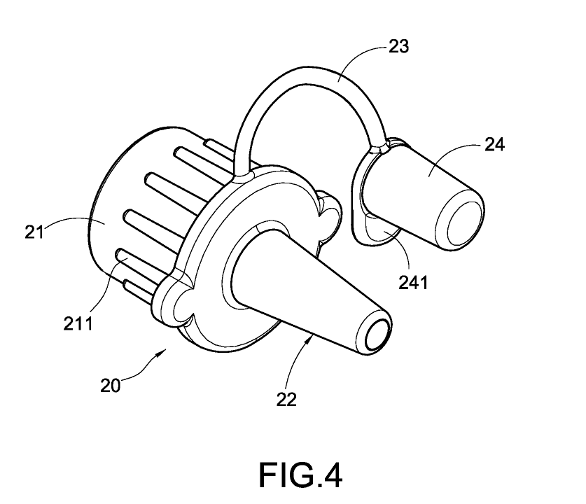

The air adapter 20 includes a circular sheathing bushing 21, a connecting tube 22 extended from an end of the sheathed bushing 21 and sheathed onto the breathing connector 12 of the sheathing bushing 21, and a plurality protruding ribs 211 parallel to an axial center of the air adapter 20 and disposed around the outside of the air adapter 20 for facilitating the adapter 20 to be secured to or removed from the connecting tube body 10. Further, the interior of the sheathing bushing 21 is interconnected with the interior of the connecting tube 22, and the external circumference of the connecting tube 22 is smaller than the external circumference of the sheathing bushing 21, and these external circumferences are preferably equal to φ 7 mm and φ 16 mm or any other dimensions. The connecting tube 22 is in a conical shape (as shown in FIG. 4), and the external diameter of an end away from the sheathing bushing is smaller than the external diameter of an end proximate to the sheathing bushing, and the connecting tube 22 of this embodiment forms a plurality of overlapped cascade rings 221 on the external surface of the conical tube. In addition, a connecting strap 23 is extended outward from a position that connects the sheathing bushing 21 and the connecting tube 22, and an end of the connecting strap 23 is connected to a cap 24, and the cap 24 is provided for covering the cascade ring 221 of the connecting tube 22 (as shown in FIG. 2), and an ear portion 241 is protruded outward from a lateral side of the cap 24 for facilitating users to pull the connecting tube 22.

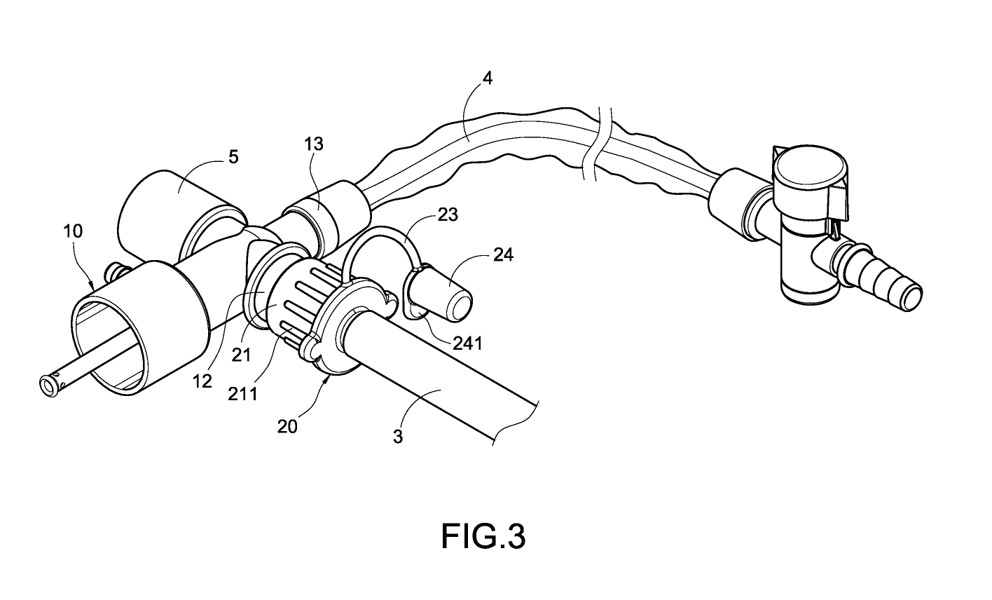

Referring to FIG. 3 for a perspective view of an air line adapter connected to an oxygen tube and a suction tube in accordance with the present invention, the air line adapter can be connected to an oxygen tube 3, a suction apparatus 4 and a cover 5 to form a suction apparatus. When the suction apparatus is installed, an end of the oxygen tube 3 is sheathed onto the connecting tube 22, and the suction apparatus 4 is connected to a suction connector 13 of the connecting tube body 10, and the standby connector 14 is covered by the cover 5. If the suction apparatus is in use, the air tube connector 11 of the connecting tube body 10 is fixed to a patient's bronchus, such that oxygen can be delivered by the oxygen tube 3 and supplied to the patient for breathing, and another end of the suction apparatus 4 is connected to a negative pressure generator (not shown in the figure), such that a medial professional can press and operate the negative pressure generator to perform suctions for the patient at the same time.

In summation of the description above, the air line adapter structure of a suction apparatus in accordance with the present invention definitely has the following advantages. Since the breathing connector 12 of the connecting tube body 10 is provided for connecting the serpentine tube and the air adapter 20 separately, therefore the scope of application can be broadened regardless of such suction apparatus being used in a ward or an intensive care unit. Further, the connecting tube 22 is in a conical shape and forms a plurality of cascade rings 221, such that when an oxygen tube is connected, the tube can be connected tightly to prevent a possible leak of air or a possible separation of tubes effectively. The cap 24 is connected to the adapter 20 by the connecting strap 23, such that when the oxygen supply is not needed, the cap 24 can be covered directly onto the connecting tube 22 to improve the convenience of use.

In summation of the description above, the air line adapter structure of a suction apparatus of the present invention herein enhances the performance over the conventional structure and further complies with the patent application requirements, and thus duly applied for the patent application.

The present invention is illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An air line adapter structure of a suction apparatus, comprising:
a connecting tube body, including an air tube connector, a breathing connector interconnected to the air tube connector, and a suction connector interconnected to the air tube connector and the breathing connector; and
an air adapter, including a sheathing bushing and a connecting tube extended from an end of the sheathed bushing, and the interior of the sheathing bushing is interconnected with the interior of the connecting tube, and the sheathing bushing is sheathed onto the breathing connector of the connecting tube body, and the external circumference of the connecting tube is smaller than the external circumference of the sheathing bushing.

2. The air line adapter structure of a suction apparatus of claim 1, wherein the connecting tube body is in a cross-shape.

3. The air line adapter structure of a suction apparatus of claim 1, wherein the sheathing bushing includes a plurality of protruding ribs disposed parallel to an axial center of the sheathing bushing and around the outside of the sheathing bushing.

4. The air line adapter structure of a suction apparatus of claim 1, wherein the connecting tube is in a conical shape, and the external diameter of an end away from the sheathing bushing is smaller than the external diameter of an end proximate to the sheathing bushing.

5. The air line adapter structure of a suction apparatus of claim 4, wherein the connecting tube includes a plurality of overlapped cascade rings disposed on an external surface of the connecting tube.

6. The air line adapter structure of a suction apparatus of claim 5, further comprising a connecting strap extended from a position that connects the sheathing bushing and the connecting tube, and a cap connected to an end of the connecting strap for covering the cascade ring of the connecting tube.

7. The air line adapter structure of a suction apparatus of claim 6, wherein the cap includes an ear portion protruded from a lateral side of the cap.
